(19) United States
(12) Patent Application Publication
(10) Pub. No.: US 2006/0046145 A1
(43) Pub. Date: Mar. 2, 2006

(54) Nonaqueous electrolytic cell

(75) Inventors: Takao Inoue, Kobe-shi (JP); Masahisa Fujimoto, Osaka-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/207,726

(22) Filed: Aug. 22, 2005

(30) Foreign Application Priority Data
Aug. 24, 2004 (JP) JP2004-243205

(51) Int. Cl. H01M 4/62

(52) U.S. Cl. 429/232; 429/217

(57) ABSTRACT

Provided is a nonaqueous electrolytic cell capable of inhibiting a positive electrode from cracking when the positive electrode is bent for cylindrically or angularly preparing the nonaqueous electrolytic cell despite employment of a conductive material having higher true density than carbon. This nonaqueous electrolytic cell comprises a positive electrode including a positive electrode active material layer, a negative electrode including a negative electrode active material layer, a nonaqueous electrolyte, a conductive material, contained in the positive electrode active material layer, including at least one material selected from a group consisting of nitrides, carbides and borides other than carbon and a binder, contained in the positive electrode active material layer, including a copolymer of vinylidene fluoride, tetrafluoroethylene and hexafluoropropylene.

### BACKGROUND OF THE INVENTION

1. Field of the Invention

The present invention relates to a nonaqueous electrolytic cell, and more particularly, it relates to a nonaqueous electrolytic cell having a positive electrode active material layer containing a binder.

2. Description of the Background Art

A lithium secondary cell is generally known as a high-capacity nonaqueous electrolytic cell. In a conventional lithium secondary cell, graphite (carbon), for example, is employed as a conductive material contained in a positive electrode active material layer, as disclosed in Japanese Patent Laying-Open No. 9-92265 (1997), for example. In the conventional lithium secondary cell disclosed in the aforementioned Japanese Patent Laying-Open No. 9-92265, however, it is difficult to increase the density of the positive electrode active material layer due to low true density (2.2 g/ml) of carbon contained in the positive electrode active material layer as the conductive material. Thus, it is disadvantageously hard to increase the capacity of the lithium secondary cell (nonaqueous electrolytic cell).

In order to increase the capacity of the lithium secondary cell, a material having true density higher than that (2.2 g/ml) of carbon may be employed as the conductive material contained in the positive electrode active material layer.

In the material having higher true density than carbon, however, the spacing between particles constituting the material is reduced to disadvantageously deteriorate flexibility. When the material having higher true density than carbon is employed as the conductive material contained in the positive electrode active material layer, therefore, flexibility of the positive electrode active material layer is disadvantageously reduced. In this case, the flexibility of a positive electrode including the positive electrode active material layer is so reduced that the positive electrode is easily cracked when bent for preparing a cylindrical or angular lithium secondary cell (nonaqueous electrolytic cell).

### SUMMARY OF THE INVENTION

The present invention has been proposed in order to solve the aforementioned problem, and an object thereof is to provide a nonaqueous electrolytic cell capable of inhibiting a positive electrode from cracking when the positive electrode is bent for cylindrically or angularly preparing the nonaqueous electrolytic cell despite employment of a conductive material having higher true density than carbon.

In order to attain the aforementioned object, a nonaqueous electrolytic cell according to an aspect of the present invention comprises a positive electrode including a positive electrode active material layer, a negative electrode including a negative electrode active material layer, a nonaqueous electrolyte, a conductive material, contained in the positive electrode active material layer, including at least one material selected from a group consisting of nitrides, carbides and borides other than carbon and a binder, contained in the positive electrode active material layer, including a copolymer of vinylidene fluoride, tetrafluoroethylene and hexafluoropropylene.

In the nonaqueous electrolytic cell according to this aspect, as hereinabove described, the copolymer of vinylidene fluoride, tetrafluoroethylene and hexafluoropropylene is so employed as the binder contained in the positive electrode active material layer that flexibility of the positive electrode active material layer can be improved due to the copolymer of vinylidene fluoride, tetrafluoroethylene and hexafluoropropylene having relatively high flexibility among materials employable as binders, despite the conductive material including at least one material selected from the group consisting of nitrides, carbides and borides, which are easily reduced in flexibility due to true density higher than that of carbon. Thus, the positive electrode including the positive electrode active material layer can be improved despite the conductive material prepared from at least one material selected from the group consisting of nitrides, carbides and borides, whereby the positive electrode can be inhibited from cracking when bent for cylindrically or angularly preparing the nonaqueous electrolytic cell. Further, at least one material selected from the group consisting of nitrides, carbides and borides other than carbon is so employed as the conductive material contained in the positive electrode active material layer that density of the positive electrode active material layer (mass of the positive electrode active material layer per volume) can be increased as compared with a case of employing carbon as the conductive material since the true density of at least one material selected from the group of nitrides (true density: 5 g/ml to 14 g/ml), carbides (true density: 4 g/ml to 17 g/ml) and borides (true density: 4 g/ml to 15 g/ml) is higher than that (2.2 g/ml) of carbon. Thus, the capacity of the positive electrode active material layer per volume can be increased. Further, at least one material selected from the group consisting of nitrides, carbides and borides employed as the conductive material hardly chemically reacts with the nonaqueous electrolyte and a positive electrode active material constituting the positive electrode active material layer under a high voltage (at least 4 V) dissimilarly to carbon, whereby the conductive material can be inhibited from reduction of capacity resulting from chemical reaction. When at least one material selected from the group consisting of nitrides, carbides and borides having conductivity close to that of carbon is employed as the conductive material, superior conductivity can be ensured.

In the nonaqueous electrolytic cell according to the aforementioned aspect, the positive electrode active material layer preferably contains at least 1 percent by mass and not more than 15 percent by mass of the copolymer of vinylidene fluoride, tetrafluoroethylene and hexafluoropropylene constituting the binder. When the positive electrode active material layer contains at least 1 percent by mass of the copolymer of vinylidene fluoride, tetrafluoroethylene and hexafluoropropylene, the flexibility of the positive electrode active material layer can be so improved that the flexibility of the positive electrode can be easily improved. Thus, the positive electrode can be easily inhibited from cracking when bent for cylindrically or angularly preparing the nonaqueous electrolytic cell. When the positive electrode active material layer contains not more than 15 percent by mass of the copolymer of vinylidene fluoride, tetrafluoroethylene and hexafluoropropylene, the nonaqueous electrolytic cell can be inhibited from reduction of capacity resulting from a large content of the binder in the positive electrode active material layer. Consequently, it is possible to suppress reduction of the capacity of the nonaqueous electrolytic cell while inhibiting the positive electrode from cracking when the active material layer contains at least 1 percent by mass and not more than 15 percent by mass of the copolymer of vinylidene fluoride, tetrafluoroethylene and hexafluoropropylene constituting the binder.

In the nonaqueous electrolytic cell according to the aforementioned aspect, the positive electrode is preferably cylindrically or angularly formed. When the nonaqueous electrolytic cell is cylindrically or angularly prepared, the positive electrode is easily cracked. Therefore, the binder including the copolymer of vinylidene fluoride, tetrafluoroethylene and hexafluoropropylene according to the aforementioned aspect is so employed that the positive electrode can be easily inhibited from cracking when bent for cylindrically or angularly preparing the nonaqueous electrolytic cell.

In this case, the positive electrode is preferably cylindrically formed. According to this structure, the positive electrode can be easily inhibited from cracking when cylindrically bent for cylindrically preparing the nonaqueous electrolytic cell.

In the nonaqueous electrolytic cell according to the aforementioned aspect, a positive electrode active material constituting the positive electrode active material layer preferably has a layered rock salt structure. According to this structure, the density of the positive electrode active material layer can be easily increased since the positive electrode active material of the layered rock salt structure has higher true density than a positive electrode active material of a spinel structure.

In this case, the positive electrode active material having the layered rock salt structure is preferably composed of a material containing at least either cobalt or nickel. For example, the true density (5 g/ml) of layered rock salt lithium cobaltate or that (4.8 g/ml) of layered rock salt lithium nickelate is higher than the true density (4.3 g/ml) of spinel lithium manganate, and hence the density of the positive electrode active material layer can be easily increased when layered rock salt lithium cobaltate or layered rock salt lithium nickelate is employed as the positive electrode active material constituting the positive electrode active material layer.

In the aforementioned case where the positive electrode active material having the layered rock salt structure is composed of the material containing at least either cobalt or nickel, the positive electrode active material having the layered rock salt structure is preferably composed of a material containing cobalt. According to this structure, the density of the positive electrode active material layer can be more easily increased.

In the nonaqueous electrolytic cell according to the aforementioned aspect, the conductive material preferably includes a metallic carbide. The true density (4 g/ml to 17 g/ml) of a metallic carbide is higher than that (2.2 g/ml) of carbon, and hence the density of the positive electrode active material layer can be easily increased by employing the metallic carbide as the conductive material. In this case, excellent conductivity can be easily ensured when a metallic carbide having specific resistance close to that (4×10⁻⁵ Ωcm to 7×10⁻⁵ Ωcm) of carbon is employed as the conductive material.

In the aforementioned nonaqueous electrolytic cell including the conductive material consisting of the metallic carbide, the metallic carbide preferably includes tungsten carbide. Tungsten carbide has true density (15.77 g/ml) higher than that (2.2 g/ml) of carbon and specific resistance (8×10⁻⁵ Ωcm) close to that (4×10⁻⁵ Ωcm to 7×10⁻⁵ Ωcm) of carbon, whereby the density of the positive electrode active material layer can be easily increased while ensuring excellent conductivity when the conductive material is prepared from tungsten carbide.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a photograph showing a positive pole of a lithium secondary cell according to Example wound on a columnar member of 3 mm in diameter;

FIG. 2 is a photograph showing a positive pole of another lithium secondary cell according to Example wound on a columnar member of 2 mm in diameter;

FIG. 3 is a photograph showing a positive pole of still another lithium secondary cell according to Example wound on a columnar member of 0.4 mm in diameter;

FIG. 4 is a photograph showing a positive pole of a lithium secondary cell according to comparative example wound on a columnar member of 10 mm in diameter;

FIG. 5 is a photograph showing a positive pole of another lithium secondary cell according to comparative example wound on a columnar member of 7 mm in diameter;

FIG. 6 is a photograph showing a positive pole of still another lithium secondary cell according to comparative example wound on a columnar member of 5 mm in diameter; and

FIG. 7 is a photograph showing a positive pole of a further lithium secondary cell according to comparative example wound on a columnar member of 3 mm in diameter.

### DESCRIPTION OF THE PREFERRED EMBODIMENTS

Example of the present invention is now specifically described.

In relation to this application, positive poles of nonaqueous electrolytic cells according to Example corresponding to the present invention and those of nonaqueous electrolytic cells according to comparative example were prepared and subjected to comparison of flexibility, in order to check flexibility of a positive pole of a cylindrical lithium secondary cell.

[Preparation of Positive Pole]

### EXAMPLE

In Example of the present invention, layered rock salt lithium cobaltate (LiCoO₂) and tungsten carbide (WC) having true density of 15.77 g/ml were employed as a positive electrode active material constituting a positive electrode active material layer and a conductive material respectively.

According to Example, a copolymer of vinylidene fluoride (VDF), tetrafluoroethylene (TFE) and hexafluoropropylene (HFP) was employed as a binder constituting the positive electrode active material layer.

The positive electrode active material of lithium cobaltate (LiCoO₂), the conductive material of tungsten carbide (WC) and the binder of the copolymer of vinylidene fluoride (VDF), tetrafluoroethylene (TFE) and hexafluoropropylene (HFP) were mixed with each other so that the mass ratios of LiCoO₂:WC:(VDF+TFE+HFP) were 92:5:3. Thereafter N-methyl-2-pyrolidone was added to this mixture for preparing a positive mixture slurry for the positive electrode active material layer.

Then, the positive mixture slurry for the positive electrode active material layer was applied to both of the front and back surfaces of an aluminum foil employed as a collector having a thickness of 20 μm. At this time, the positive mixture slurry was so applied that the amount thereof was 50 mg/cm² on both surfaces (front and back surfaces) of the aluminum foil. In this case, the total thickness of the positive mixture slurry (positive electrode active material layer) excluding the aluminum foil was 125 μm. In this Example, the density of the positive electrode active material layer was 4.0 g/ml. The positive electrode of the lithium secondary cell according to Example was prepared in the aforementioned manner.

### COMPARATIVE EXAMPLE

In comparative example, polyacrylonitrile (PAN) was employed as a binder constituting a positive electrode active material layer, dissimilarly to the aforementioned Example. Lithium cobaltate (LiCoO₂) and tungsten carbide (WC) were employed as a positive electrode active material layer constituting the positive electrode active material layer and a conductive material respectively, similarly to the aforementioned Example.

The positive electrode active material of lithium cobaltate (LiCoO₂), the conductive material of tungsten carbide (WC) and the binder of polyacrylonitrile (PAN) were mixed with each other so that the mass ratios of LiCoO₂:WC:PAN were 92:5:3. Thereafter N-methyl-2-pyrolidone was added to this mixture for preparing a positive mixture slurry for the positive electrode active material layer.

Then, the positive mixture slurry for the positive electrode active material layer was applied to both of the front and back surfaces of an aluminum foil employed as a collector having a thickness of 20 μm, similarly to the above Example. At this time, the positive mixture slurry was so applied that the amount thereof was 50 mg/cm² on both surfaces of the aluminum foil. In this case, the total thickness of the positive mixture slurry excluding the aluminum foil was 125 μm, identically to the thickness of the positive mixture slurry employed in the above Example. In this comparative example, the density of the positive electrode active material layer was 4.0 g/ml, identically to the density of the positive electrode active material layer according to the above Example. The positive electrode of the lithium secondary cell according to comparative example was prepared in the aforementioned manner.

[Positive Electrode Flexibility Experiment]

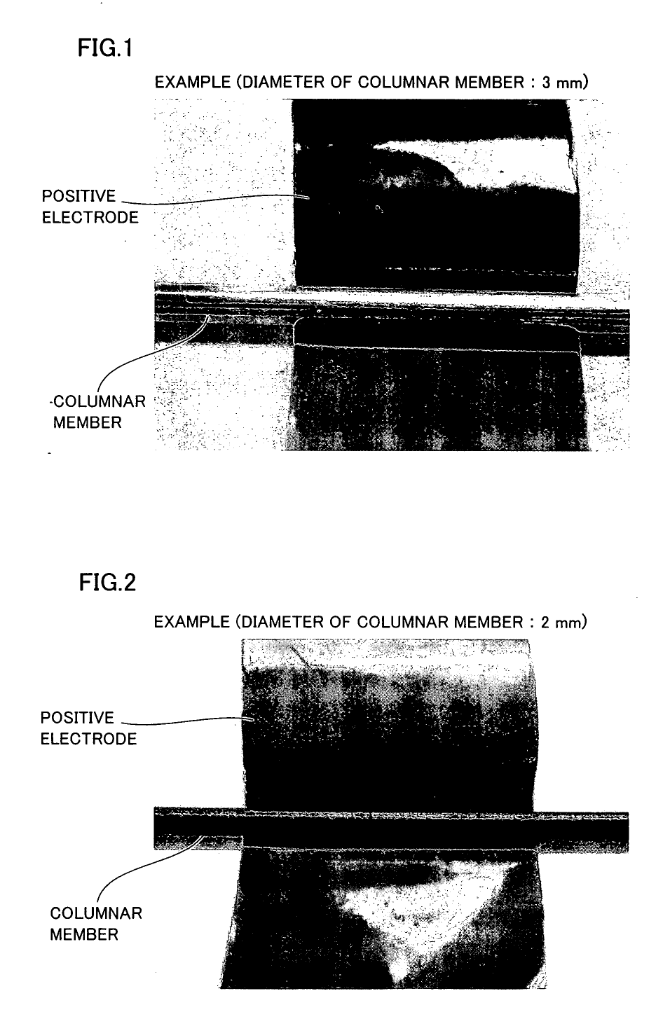

A flexibility experiment was made on the positive electrodes of the lithium secondary cells according to Example and comparative example prepared in the aforementioned manner. More specifically, the situations of cracking of the positive electrodes according to Example and comparative example were checked by bending the positive electrodes along outer edges of a plurality of types of columnar members having different diameters assuming a case of forming cylindrical lithium secondary cells. Six types of columnar members having diameters of 0.4 mm, 2 mm, 3 mm, 5 mm, 7 mm and 10 mm respectively were employed for this flexibility experiment. The positive electrodes according to Example were subjected to the flexibility experiment with three types of columnar members having the diameters of 0.4 mm, 2 mm and 3 mm respectively. On the other hand, the positive electrodes according to comparative example were subjected to the flexibility experiment with four types of columnar members having the diameters of 3 mm, 5 mm, 7 mm and 10 mm respectively. Table 1 shows results of this flexibility experiment, while FIGS. 1 to 7 show the positive electrodes according to Example and comparative example wound on the columnar members respectively. Referring to Table 1, marks ◯ and X denote uncracked and cracked positive electrodes respectively.

TABLE 1

| | | Radius of Curvature | | |
|---|---|---|---|---|
| | Radius of | with respect | | |
| Diameter of | Curvature of | to Thickness | | |
| Columnar | Positive | (125 μm) of Positive | | Compar- |
| Member | Electrode | Electrode Active | | ative |
| (mm) | (mm) | Material Layer | Example | Example |
| 0.4 | 0.2 | 1.6 times | ο | — |
| 2 | 1 | 8 times | ο | — |
| 3 | 1.5 | 12 times | ο | X |
| 5 | 2.5 | 20 times | — | X |
| 7 | 3.5 | 28 times | — | X |
| 10 | 5 | 40 times | — | ο |

Referring to Table 1, it has been proved that the lower limit (not more than 0.2 mm) of the radius of curvature of the positive electrode capable of inhibiting the positive electrode from cracking is smaller in Example employing the copolymer of vinylidene fluoride, tetrafluoroethylene and hexafluoropropylene as the binder for the conductive material of tungsten carbide forming the positive electrode active material layer as compared with the lower limit (5 mm) of the radius of curvature of the positive electrode capable of inhibiting the positive electrode from cracking in comparative example employing polyacrylonitrile as the binder.

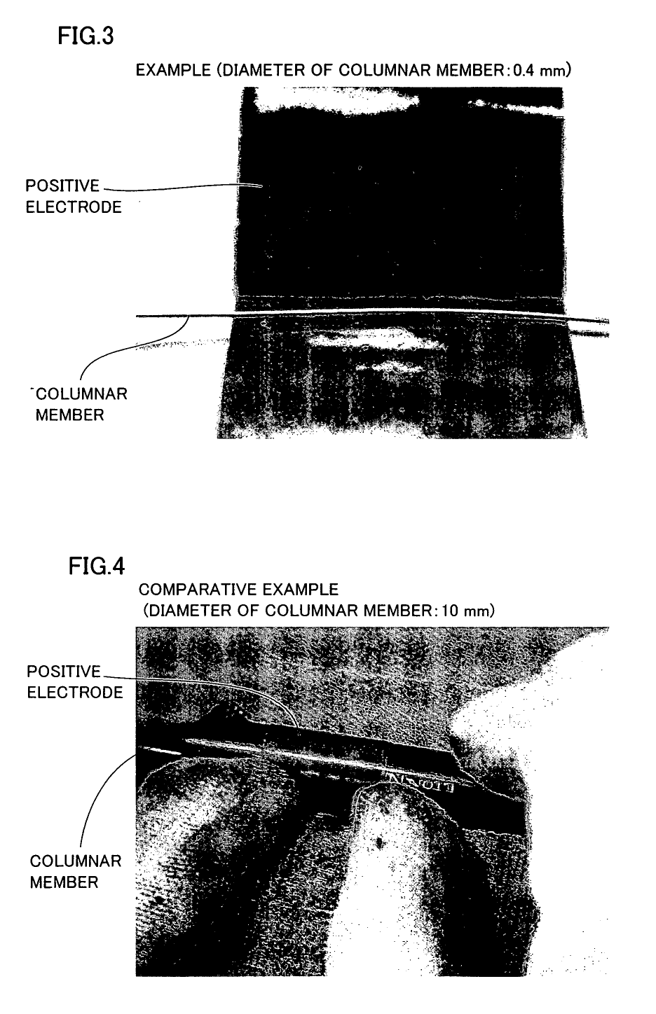

According to Example, it was possible to inhibit the positive electrode having the radius of curvature of 1.5 mm (12 times the thickness (125 μm) of the positive electrode active material layer) from cracking when the same was wound on the columnar member having the diameter of 3 mm, as shown in Table 1 and FIG. 1. It was also possible to inhibit the positive electrode having the radius of curvature of 1 mm (8 times the thickness (125 μm) of the positive electrode active material layer) from cracking when the same was wound on the columnar member having the diameter of 2 mm, as shown in Table 1 and FIG. 2. It was also possible to inhibit the positive electrode having the radius of curvature of 0.2 mm (1.6 times the thickness (125 μm) of the positive electrode active material layer) from cracking when the same was wound on the columnar member having the smallest diameter of 0.4 mm, as shown in Table 1 and FIG. 3. In other words, it has been proved possible to inhibit the positive electrode from cracking when the radius of curvature thereof is at least 0.2 mm (1.6 times the thickness (125 μm) of the positive electrode active material layer) according to Example employing tungsten carbide and the copolymer of vinylidene fluoride, tetrafluoroethylene and hexafluoropropylene for the conductive material and the binder respectively.

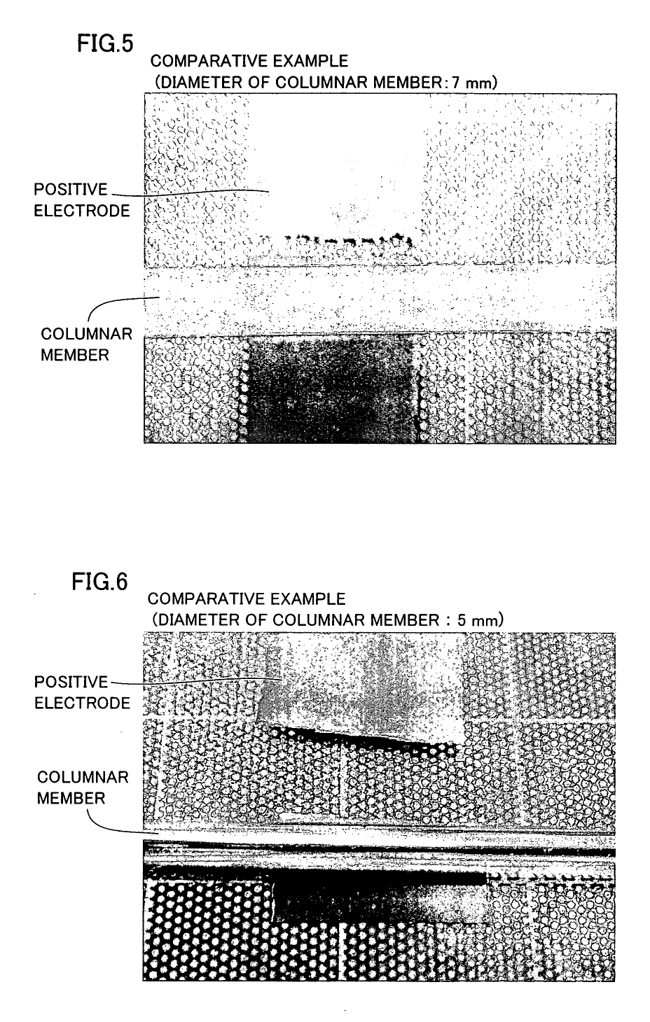

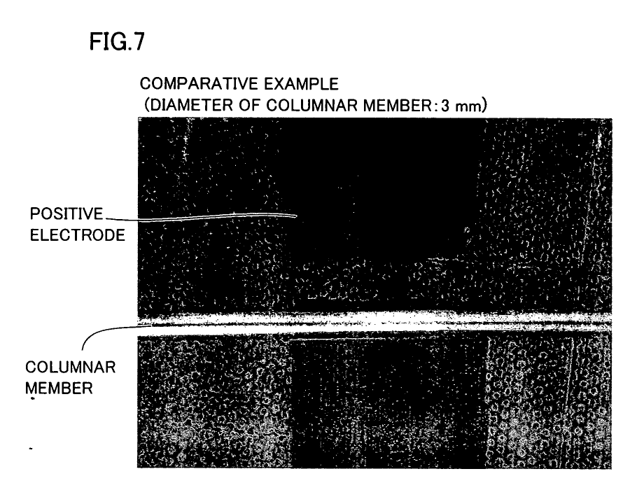

According to comparative example, on the other hand, it was possible to inhibit the positive electrode having the radius of curvature of 5 mm (40 times the thickness (125 μl) of the positive electrode active material layer) from cracking when the same was wound on the columnar member having the diameter of 10 mm, as shown in Table 1 and FIG. 4. However, the positive electrode having the radius of curvature of 3.5 mm (28 times the thickness (125 μm) of the positive electrode active material layer) was cracked when the same was wound on the columnar member having the diameter of 7 mm, as shown in Table 1 and FIG. 5. Further, the positive electrode having the radius of curvature of 2.5 mm (20 times the thickness (125 μm) of the positive electrode active material layer) was also cracked when the same was wound on the columnar member having the diameter of 5 mm, as show in Table 1 and FIG. 6. The positive electrode having the radius of curvature of 1.5 mm (12 times the thickness (125 μm) of the positive electrode active material layer) was also cracked when the same was wound on the columnar member having the diameter of 3 mm, as show in Table 1 and FIG. 7. In other words, it has been proved necessary to increase the radius of curvature of the positive electrode according to comparative example, employing tungsten carbide and polyacrylonitrile for the conductive material and the binder respectively, beyond 5 mm (40 times the thickness (125 μm) of the positive electrode active material layer), in order to inhibit the positive electrode from cracking.

It is inferable from these results that the positive electrode, including the positive electrode active material layer formed by the conductive material of tungsten carbide and the binder of the copolymer of vinylidene fluoride, tetrafluoroethylene and hexafluoropropylene, is more improved in flexibility as compared with a positive electrode including a positive electrode active material layer formed by a binder of polyacrylonitrile.

According to Example, as hereinabove described, the copolymer of vinylidene fluoride, tetrafluoroethylene and hexafluoropropylene having relatively high flexibility among materials employable as binders is so employed as the binder for the positive electrode active material layer that the positive electrode active material layer can be improved in flexibility despite the conductive material prepared from tungsten carbide (WC), which is easily reduced in flexibility due to the true density higher than that of carbon. Thus, the positive electrode including the positive electrode active material layer can be improved in flexibility despite the conductive material prepared from tungsten carbide, whereby the positive electrode can be inhibited from cracking when bent for preparing a cylindrical lithium secondary cell (nonaqueous electrolytic cell). As to a positive electrode of a lithium secondary cell, density of a positive electrode active material layer is preferably set to at least 4.0 g/ml, while the positive electrode is preferably not cracked when bent into a radius of curvature of not more than 12.5 times the thickness of the positive electrode active material layer. The positive electrode according to Example, not cracked when bent in the range of the radius of curvature of at least 1.6 times and not more 12 times the thickness (125 μm) of the positive electrode active material layer as described above, satisfies this condition.

Although the present invention has been described and illustrated in detail, it is clearly understood that the same is by way of illustration and example only and is not to be taken by way of limitation, the spirit and scope of the present invention being limited only by the terms of the appended claims.

For example, while the present invention has been applied to the positive electrode of the lithium secondary cell in the aforementioned Example, the present invention is not restricted to this but is also applicable to a positive electrode of a nonaqueous electrolytic cell other than the lithium secondary cell.

While layered rock salt lithium cobaltate has been employed as the positive electrode active material in the aforementioned Example, the present invention is not restricted to this but the positive electrode active material may alternatively be prepared from another layered rock salt material, other than rock salt lithium cobaltate, so far as the same contains at least either cobalt or nickel. The layered rock salt material containing at least either cobalt or nickel can be prepared from a lithium-cobalt composite oxide having a composition formula LiCOₐM₁₋ₐO₂ (0<a≦1), for example. In this composition formula LiCOₐM₁₋ₐO₂, M represents at least one element selected from a group consisting of B, Mg, Al, Ti, Mn, V, Fe, Ni, Cu, Zn, Ga, Y, Zr, Nb, Mo and In. A lithium-nickel composite oxide having a composition formula LiNi_{b}M_{1-b}O₂ (0<b≦1) can also be listed. In the composition formula LiNi_{b}M_{1-b}O₂, M represents at least one element selected from a group consisting of B, Mg, Al, Ti, Mn, V, Fe, Co, Cu, Zn, Ga, Y, Zr, Nb, Mo and In.

While the content of tungsten carbide serving as the conductive material in the positive electrode active material layer has been set to 5 percent by mass in the aforementioned Example, the present invention is not restricted to this but the content of tungsten carbide for serving as the conductive material in the positive electrode active material layer may conceivably be preferably not more than 25 percent by mass. This is because the ratio of the positive electrode active material to the positive electrode active material layer is reduced to conceivably reduce the capacity of the cell when the content of tungsten carbide employed as the conductive material exceeds 25%. Therefore, the content of tungsten carbide serving as the conductive material is conceivably more preferably set to at least 1% and not more than 25%, since relatively high capacity can be obtained in this case. Further, the content of tungsten carbide serving as the conductive material is conceivably most preferably set to at least 1% and not more than 7%, since extremely high capacity can be obtained in this case.

The average particle diameter of tungsten carbide employed as the conductive material in the aforementioned Example is preferably not more than 5 μm. This is because the conductive material contained in the positive electrode active material layer is homogeneously dispersed and improved in dispersibility so that excellent conductivity can conceivably be ensured if the average particle diameter of tungsten carbide employed as the conductive material is not more than 5 μm. If the average particle diameter of tungsten carbide employed as the conductive material is excessively small, the contact areas between the conductive particles contained in the positive electrode active material layer are so reduced that it may conceivably be difficult to ensure sufficient conductivity. Thus, the average particle diameter of tungsten carbide employed as the conductive material is conceivably more preferably at least 0.1 μm and not more than 3 μm.

While tungsten carbide (true density: 15.77 g/ml) has been employed as the metallic carbide constituting the conductive material having true density higher than that (2.2 g/ml) of carbon in the aforementioned Example, the present invention is not restricted to this but a similar effect can be attained also when at least one material, other than tungsten carbon, selected from a group consisting of nitrides (true density: 5 g/ml to 14 g/ml), carbides (true density: 4 g/ml to 17 g/ml) and borides (true density: 4 g/ml to 15 g/ml) having true density higher than that (2.2 g/ml) of carbon is employed as the conductive material. For example, at least one material selected from a group consisting of HfC, B₄C, MoC, NbC, TaC, TiC and ZrC can be listed as a metallic carbide other than tungsten carbide. On the other hand, at least one material selected from a group consisting of NbN, TiN, Ti₃N₄, VN, Cr₂N, Fe₂N, Cu₃N, GaN, ZrN, Zr₃N₂, Mo₂N, Ru₂N, TaN, Ta₂N, HfN, ThN₂, Mo₂N, Mo₃N₂, CO₃N₂, Ni₃N₂, W₂N and Os₂N can be listed as a metallic nitride, for example. Among the aforementioned metallic carbides and metallic nitrides, ZrC, TaC, TiN, Ti₃N₄, ZrN, Zr₃N₂, TaN and Ta₂N have specific resistance values close to the specific resistance (40×10⁻⁶ Ωcm to 70×10⁻⁶ Ωcm), and hence more excellent conductivity can be ensured when one of ZrC, TaC, TiN, Ti₃N₄, ZrN, Zr₃N₂, TaN and Ta₂N is employed as the conductive material. The specific resistance of ZrC is 70×10⁻⁶ Ωcm, and that of TaC is 30×10⁻⁶ Ωcm. The specific resistance of TiN or Ti₃N₄ is 21.7×10⁻⁶ Ωcm, that of ZrN or Zr₃N₂ is 13.6×10⁻⁶ Ωcm, and that of TaN or Ta₂N is 200×10⁻⁶ Ωcm.

While tungsten carbide having specific resistance (80×10⁻⁶ Ωcm) close to that (40×10⁻⁶ Ωcm to 70×10⁻⁶ Ωcm) of carbon has been employed as the conductive material in the aforementioned Example, the present invention is not restricted to this but a conductive material inferior in conductivity to carbon may alternatively be employed so far as the density of the positive electrode active material layer can be increased.

While the content of the copolymer of vinylidene fluoride, tetrafluoroethylene and hexafluoropropylene for serving as the binder in the positive electrode active material layer has been set to 3 percent by mass in the aforementioned Example, the present invention is not restricted to this but the content of the copolymer of vinylidene fluoride, tetrafluoroethylene and hexafluoropropylene for serving as the binder in the positive electrode active material layer is conceivably preferably set to at least 1 percent by mass and not more than 15 percent by mass, since flexibility of the positive electrode can be improved and reduction of the capacity of the nonaqueous electrolytic cell can be suppressed in this case. In other words, the flexibility of the positive electrode active material layer can be so improved that the flexibility of the positive electrode can be easily improved when the positive electrode active material layer contains the copolymer of vinylidene fluoride, tetrafluoroethylene and hexafluoropropylene at the ratio of at least 1 percent by mass. Thus, the positive electrode can be easily inhibited from cracking when bent for cylindrically or angularly preparing the nonaqueous electrolytic cell. When the positive electrode active material layer contains the copolymer of vinylidene fluoride, tetrafluoroethylene and hexafluoropropylene at the ratio of not more than 15 percent by mass, on the other hand, the nonaqueous electrolytic cell can be inhibited from reduction of capacity resulting from a large content of the binder in the positive electrode active material. Consequently, the positive electrode can be inhibited from cracking while the nonaqueous electrolytic cell can be inhibited from reduction of capacity when the positive electrode active material layer contains the copolymer of vinylidene fluoride, tetrafluoroethylene and hexafluoropropylene at the ratio of at least 1 percent by mass and not more than 15 percent by mass.

As a nonaqueous solvent employable for preparing a nonaqueous electrolytic cell with the positive electrode according to the aforementioned Example, cyclic carbonate, chain carbonate, ester, cyclic ether, chain ether, nitrile or amide can be listed, for example. As examples of cyclic carbonate, ethylene carbonate, propylene carbonate and butylene carbonate can be listed, for example. Cyclic carbonate, such as trifluoropropylene carbonate or fluoroethyl carbonate, for example, having partially or entirely fluorinated hydrogen groups is also employable. On the other hand, dimethyl carbonate, ethylmethyl carbonate, diethyl carbonate, methypropyl carbonate, ethylpropyl carbonate and methylisopropyl carbonate can be listed as examples of chain carbonate, for example. Chain carbonate having partially or entirely fluorinated hydrogen groups is also employable.

As examples of ester, methyl acetate, ethyl acetate, propyl acetate, methyl propionate, ethyl propionate and γ-butylolactone can be listed, for example. As examples of cyclic ether, 1,3-dioxolane, 4-methyl-1,3-dioxolane, tetrahydrofuran, 2-methyltetrahydrofuran, propylene oxide, 1,2-butylene oxide, 1,4,-dioxane, 1,3,5-trioxane, furan, 2-methylfuran, 1,8-cineol and crown ether can be listed. As chain ether, 1,2-dimethoxyethane, diethyl ether, dipropyl ether, diisopropyl ether, dibutyl ether, dihexyl ether, ethylvinyl ether, butylvinyl ether, methylphenyl ether, ethylphenyl ether, butylphenyl ether, pentylphenyl ether, methoxy toluene, benzylethyl ether, diphenyl ether, dibenzyl ether, O-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethylether and tetraethylene glycol dimethyl can be listed, for example. Acetonitrile can be listed as nitrile, for example. Dimethylformamide can be listed as amide, for example.

As examples of a solute employable for preparing a nonaqueous electrolytic cell with the positive electrode according to the aforementioned Example, LiPF₆, difluoro(oxalate) lithium borate (substance expressed in the following chemical formula (1)), LiAsF₆, LiBF₄, LiCF₃SO₃, LiN(C₁F₂ₗ₊₁SO₂) (CₘF₂ₘ₊₁SO₂) and LiC(CₚF₂ₚ₊₁SO₂)(C_{q}F_{2q+1}SO₂)(CᵣF₂ᵣ₊₁SO₂) can be listed, for example. In the aforementioned composition formulas, each of l, m, p, q and r represents an integer of at least 1. Alternatively, a mixture obtained by combining at least two selected from a group of the aforementioned solutes with each other may be employed as the solute. The aforementioned solute is preferably dissolved in the solvent in a concentration of 0.1 M to 1.5 M. The aforementioned solute is more preferably dissolved in the solvent in a concentration of 0.5 M to 1.5 M.

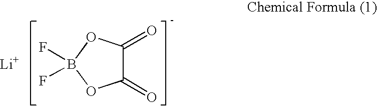

While the positive mixture slurry for forming the positive electrode active material layer has been applied to both of the front and back surfaces of the collector in the aforementioned Example, the present invention is not restricted to this but the positive mixture slurry for forming the positive electrode active material layer may alternatively be applied to only either the front or back surface of the collector.

What is claimed is:

1. A nonaqueous electrolytic cell comprising:
a positive electrode including a positive electrode active material layer;
a negative electrode including a negative electrode active material layer;
a nonaqueous electrolyte;
a conductive material, contained in said positive electrode active material layer, including at least one material selected from a group consisting of nitrides, carbides and borides other than carbon; and
a binder, contained in said positive electrode active material layer, including a copolymer of vinylidene fluoride, tetrafluoroethylene and hexafluoropropylene.

2. The nonaqueous electrolytic cell according to claim 1, wherein
said positive electrode active material layer contains at least 1 percent by mass and not more than 15 percent by mass of said copolymer of vinylidene fluoride, tetrafluoroethylene and hexafluoropropylene constituting said binder.

3. The nonaqueous electrolytic cell according to claim 1, wherein
said positive electrode is cylindrically or angularly formed.

4. The nonaqueous electrolytic cell according to claim 3, wherein
said positive electrode is cylindrically formed.

5. The nonaqueous electrolytic cell according to claim 1, wherein
a positive electrode active material constituting said positive electrode active material layer has a layered rock salt structure.

6. The nonaqueous electrolytic cell according to claim 5, wherein
said positive electrode active material having said layered rock salt structure is composed of a material containing at least either cobalt or nickel.

7. The nonaqueous electrolytic cell according to claim 6, wherein
said positive electrode active material having said layered rock salt structure is composed of a material containing cobalt.

8. The nonaqueous electrolytic cell according to claim 1, wherein
said conductive material includes a metallic carbide.

9. The nonaqueous electrolytic cell according to claim 8, wherein
said metallic carbide includes tungsten carbide.
